(19) United States
(12) Patent Application Publication
(10) Pub. No.: US 2018/0207788 A1
(43) Pub. Date: Jul. 26, 2018

(54) ADJUSTABLE SAWHORSE

(71) Applicant: KETER PLASTIC LTD., Herzelyia (IL)

(72) Inventor: Yaron BRUNNER, Kibbutz Gvat (IL)

(73) Assignee: KETER PLASTIC LTD., Herzelyia (IL)

(21) Appl. No.: 15/744,360

(22) PCT Filed: Jul. 14, 2016
(86) PCT No.: PCT/IL2016/050766

§ 371 Date: Jan. 12, 2018

Related U.S. Application Data
(60) Provisional application No. 62/192,842, filed on Jul. 15, 2015.

(51) Int. Cl. B25H 1/06; B27B 17/00; B25H 1/16

(52) U.S. Cl. CPC B25H 1/06; E04G 1/34; B25H 1/16; B27B 17/0041

(57) ABSTRACT

Provided is a height adjustable sawhorse including two rigid frame members pivotally articulated to one another and constituting a base member. Each frame member includes two legs, including a top utility portion extending from at least one of the frames. The utility portion is provided with a pair of extension members axially displaceable within the at least one frame member between a fully retracted position and a fully extracted position. The arrangement is such that at least the utility portion is configured for height adjustment relative to the base member between the two positions. The base member and the sawhorse may be provided with a locking arrangement configured for locking the extension members respective of the base member at least when in the extracted position. At least the displacement of the extension member into the retracted position may be facilitated only upon maneuvering of the locking mechanism.

### TECHNOLOGICAL FIELD

The disclosed subject matter is directed to a sawhorse and, in particular, to a sawhorse having an adjustable height.

### BACKGROUND ART

A reference considered to be relevant as background to the presently disclosed subject matter is listed below:

U.S. Pat. No. 6,298,946

Acknowledgement of the above reference herein is not to be inferred as meaning that this is in any way relevant to the patentability of the presently disclosed subject matter.

### BACKGROUND

U.S. Pat. No. 6,298,946 discloses a sawhorse comprising a base assembly including a first base member and a second base member. The first base member has a first top end, and the second base member has a second top end. The second base member is pivotally connected at the second top end to the first top end of the first base member. The first and second base members are pivotally movable between a folded storage position and an extended operative position. A vertically extendible top member is constructed and arranged to be adjustably mounted in varying vertical positions with respect to the base assembly. The extendible top member includes an elongated, laterally extending top element constructed and arranged to support a workpiece, and a pair of elongated extension elements that are constructed and arranged to be adjustably engaged at varying vertical positions relative to the base assembly so as to adjust the height of the top element.

### GENERAL DESCRIPTION

According to the present disclosure there is disclosed a height adjustable sawhorse, comprising two rigid frame members pivotally articulated to one another and constituting a base member, each frame member comprising two legs and further comprising a top utility portion extending from at least one of the frames, wherein the utility portion is provided with a pair of extension members axially displaceable within the at least one frame member between a fully retracted position and a fully extracted position such that at least the utility portion is configured for height adjustment relative to the base member, and wherein the base member is provided with a locking arrangement and wherein displacement of the extension member at least in one direction is facilitated upon maneuvering of the locking mechanism.

In accordance with an aspect of the disclosed subject matter, there is provided a height adjustable sawhorse, comprising two rigid frame members pivotally articulated to one another and constituting a base member, each frame member comprising two legs and further comprising a top utility portion extending from at least one of the frames, wherein the utility portion is provided with a pair of extension members axially displaceable within the at least one frame member between a fully retracted position and a fully extracted position such that at least the utility portion is configured for height adjustment relative the base member between the two positions, and wherein the base member and the sawhorse is provided with a locking arrangement configured for locking the extension members respective of the base member at least when in the extracted position and wherein at least the displacement of the extension member into the retracted position is facilitated only upon maneuvering of the locking mechanism.

The term utility portion as used herein in the specification and claims defines any sort of arrangement configured for supporting a workspace and the like. For example, a utility portion can be a flat surface (e.g. for supporting a board of material) or a notch configured for supporting an elongate workpiece (being for example a V-notch, a right-angled notch, a semicircular notch and the like).

According to a configuration, the utility portion is vertically displaceable with respect to the frame members. According to a particular configuration, the two frame members of the sawhorse are pivotally articulated to one another, said sawhorse being disposable between a collapsed/folded position at which the frames are substantially disposed one within the other, and an open position at which the sawhorse assumes an inverted V-like shape.

Any one or more of the following designs, features and configurations can be applied with the sawhorse of the present disclosure, separately or in various combinations thereof:
The extension members are provided with an internal halting mechanism.
At least one of the frame members is further provided with an interconnecting locking support member, extending between the respective two legs of the at least one of the frame members.
The interconnecting locking support is integrally formed with the respective frame, forming an H-like hollow structure.
The extension members coaxially extend within the legs of the at least one frame member and the locking arrangement is actuatable by one or more manipulation member provided at the interconnecting locking support member.
The locking mechanism is configured such that the gravity force acting on the extension member is lesser than friction forces extending between the respective extension member and the base member, including such forces resulting from the locking arrangement such that the extension members are prevented for spontaneously displacing into retracted configuration.
The locking arrangement comprises at least one locking mechanism associated with the respective extension members configured for arresting the extension member with respect to the respective leg portion of the frame member and an arresting lever configured to engage the locking arrangement.
The locking arrangement comprises a ratchet type locking mechanism.
The extension members are telescopically received within the respective portions of the legs of the respective frame.
The locking arrangement is configured with a biasing mechanism for retaining the locking mechanism at a normally locked position.
The biasing mechanism is integrally formed with at least a portion of the locking mechanism.
The biasing mechanism is a biasing spring configured contract and biased to expand.
The locking arrangement comprises a lever or a bolt member associated with a locking mechanism provided to engage the locking mechanism associated with each of the extension members and actuatable by a common manipulating member.
The arresting lever for the respective locking mechanisms associated with the extension members is coaxially received within the interconnecting support member
The respective arresting levers are interconnected through a biasing element, together extending within the interconnecting support member and configured to engage the arresting mechanism of the extension members, constituting together a locking arrangement.
The respective arresting lever is configured with a locking end for latch type engagement with the arresting member.
The interconnecting support member is configured with a central manipulating member extending therein for manipulation of the respective levers and exposed for manipulation.
The interconnecting support member is configured with a central manipulating member for manipulation of the respective levers, the manipulating member being provided with downwardly extending extensions configured to engage the respective lever provided with a receiving member to snugly receive the extension when maneuvered.
The respective engagement between the extensions and the levers is achieved by manipulating the manipulation member.
The length of the locking lever end corresponds to the width of the downwardly extending extension of the manipulating member.
The two levers or bolt members associated with the locking members of the two extension members are configured with a biasing mechanism for retaining the locking arrangement at a normally locked position.
All legs of the sawhorse can be configured with an extendible leg;
Extending an extension member, namely extraction displacement of an extension member can be facilitated spontaneously, i.e. without unlocking the locking mechanism;
The extendible member is telescopic, wherein the extension member is coaxially displaceable with respect to a leg portion of the frame;
The arrangement can be configured such that an extension member will not spontaneously collapse into the frame, unless the locking mechanism is activated;
The locking mechanism can be a ratchet type locking mechanism;
The locking mechanism can be an eccentric/cam type lock;
The locking mechanism can be configured with a biasing mechanism for retaining the locking mechanism at a normally locked position;
The sawhorse comprises one or more bubble levels for determining the level position of the saw horse;
One or more shelves can be articulated to the frames and be disposable between a collapsed/folded position, at which the one or more shelves are substantially stowed between the folded frames, and an open position at which the one or more shelves are disposed substantially horizontally between the two frames;
The frames can be configured as I-like frames with or without an interconnecting top portion facilitating pivotal articulation of the two frames to one another;
Pivotal articulation of the top portions of the two frame members can be facilitated by a first frame member configured with a receptacle receiving therein a corresponding pivoting segment of the second frame member, said pivoting segment configured for snug rotation within the receptacle;

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A to 1C illustrate a perspective view of a sawhorse in accordance with the disclosed subject matter in a deployed position, deployed-extended position and a collapsed position, respectively;

FIGS. 2A, 2B and 2C illustrate the sawhorse of FIG. 1C in a front view (2A) and rear view (2B), and in FIG. 2C in a cross-section taken along A-A in FIG. 2B;

FIGS. 3A-3B illustrate the sawhorse of FIG. 1A in a back perspective view and a partial front perspective view;

FIG. 3C illustrates a partial perspective front view of the sawhorse in FIG. 1B;

FIG. 3D illustrates a partially exposed locking arrangement in accordance with an example of the disclosed subject matter, with the utility portion in an extended configuration;

FIG. 3E illustrates a partially exposed locking arrangement of FIG. 3D with the utility portion in its retracted configuration;

FIGS. 4A-4C illustrate in a perspective back view a sawhorse in accordance with another example of the disclosed subject matter, in a deployed position, deployed-extended position, and a collapsed position, respectively; and

FIG. 4D illustrates the locking arrangement in accordance with another example of the disclosed subject matter in a cross-section taken along line D-D in FIG. 4B.

### DETAILED DESCRIPTION OF EMBODIMENTS

The presently disclosed subject matter is directed to a height adjustable sawhorse.

Turning now to the drawings, wherein like reference numerals refer to like parts throughout the various illustrated examples, reference numeral 100 generally designates a portable sawhorse assembly in accordance with the disclosed subject matter.

In accordance with examples of the disclosed subject matter, the portable sawhorse is at least partially constructed of a high-strength molded plastic material, although it will be appreciated that any material of suitable strength and weight, such as metal, polymeric material, etc. can be used in all or any portion thereof.

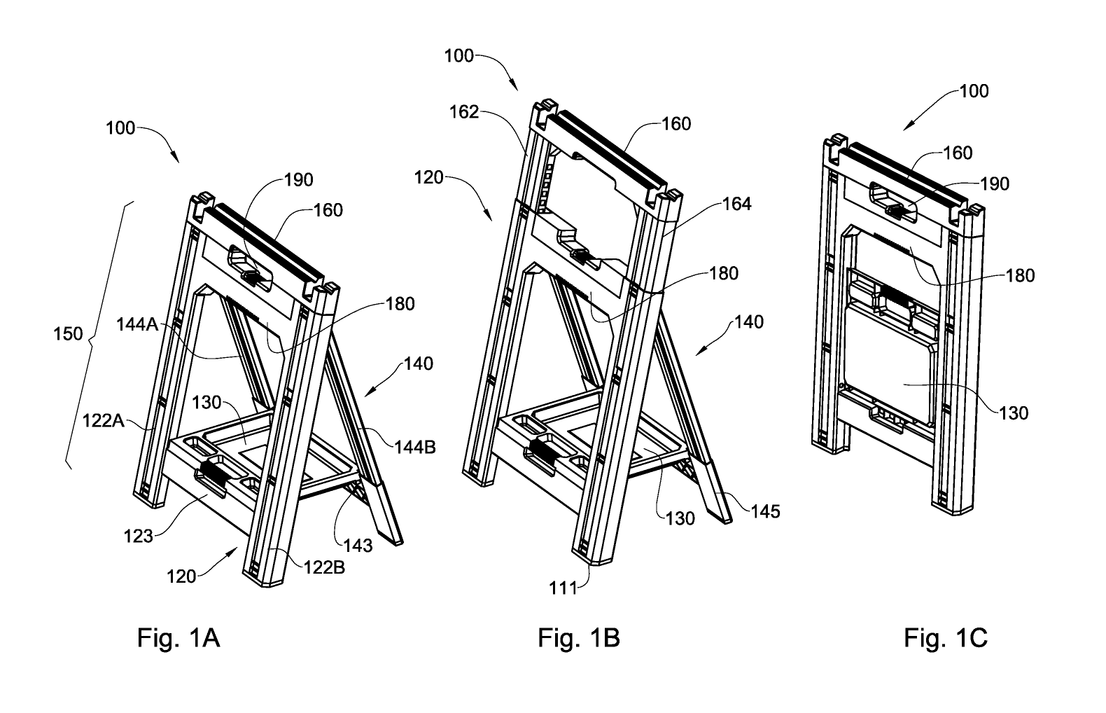

Attention is now directed to FIGS. 1A-1C illustrating a sawhorse generally designated as 100 in accordance with an example of the disclosed subject matter.

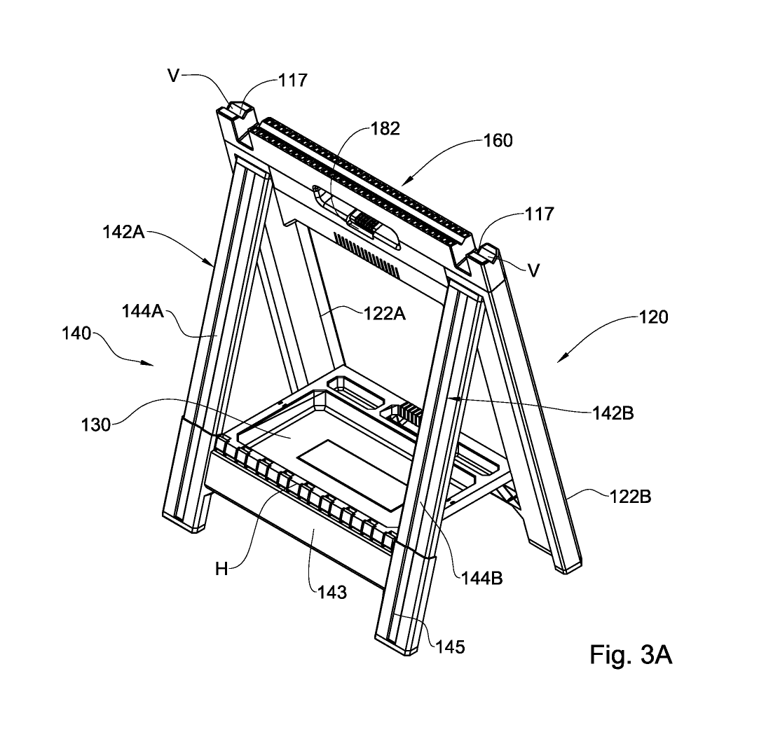

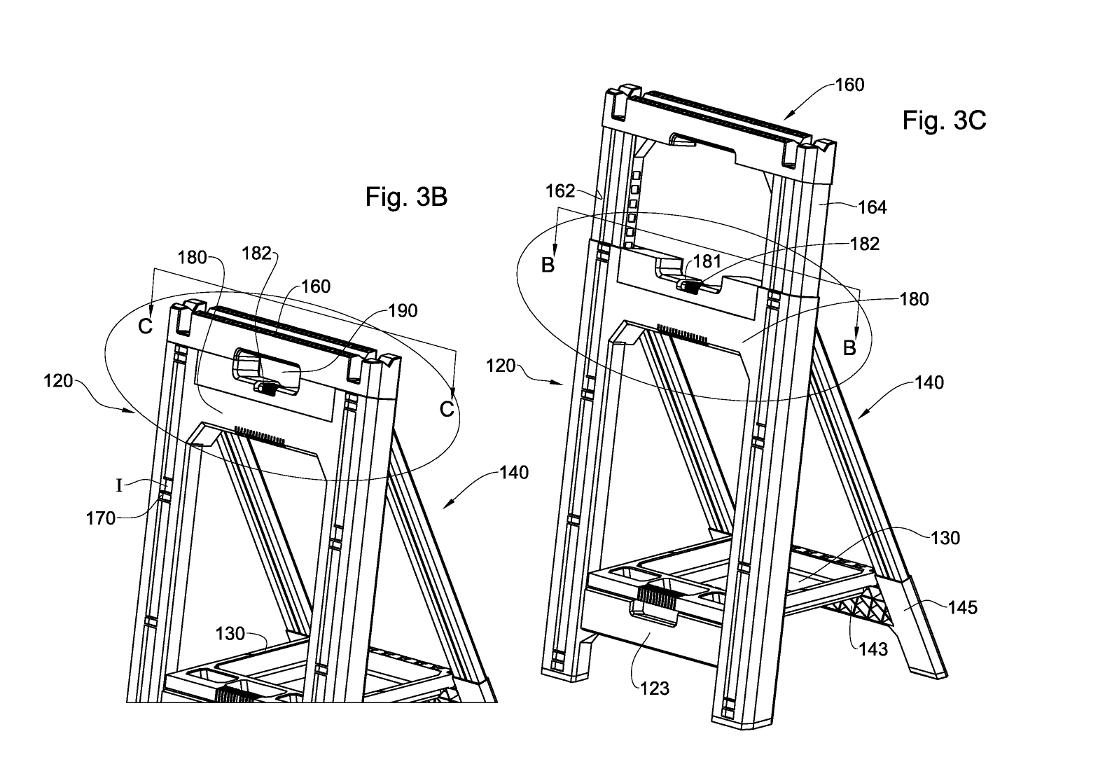

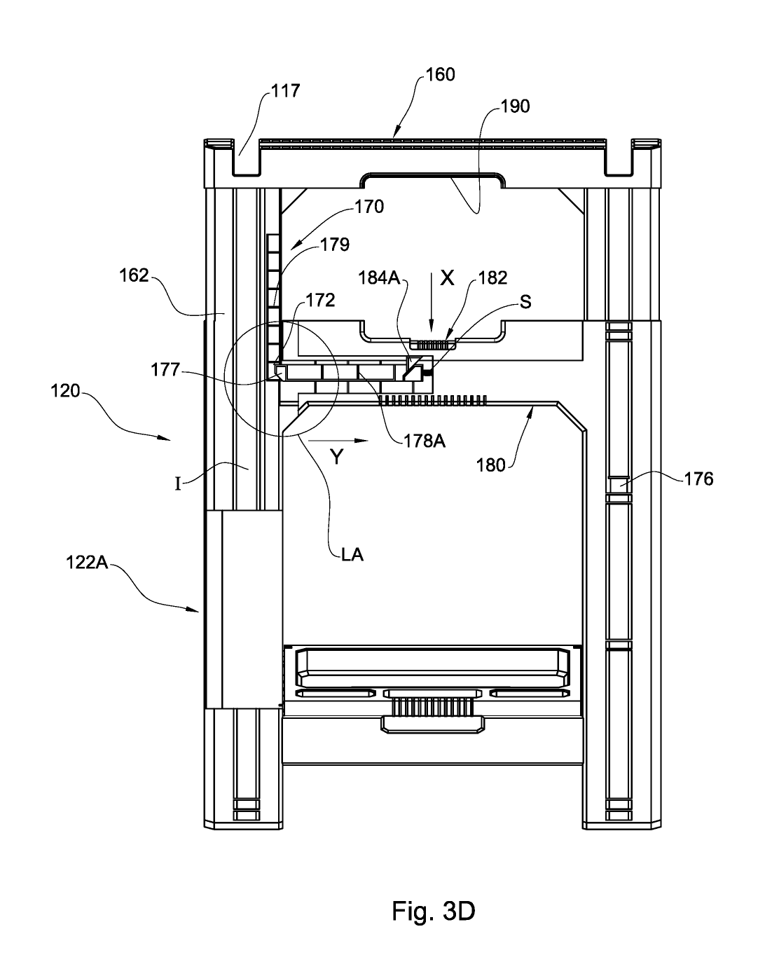

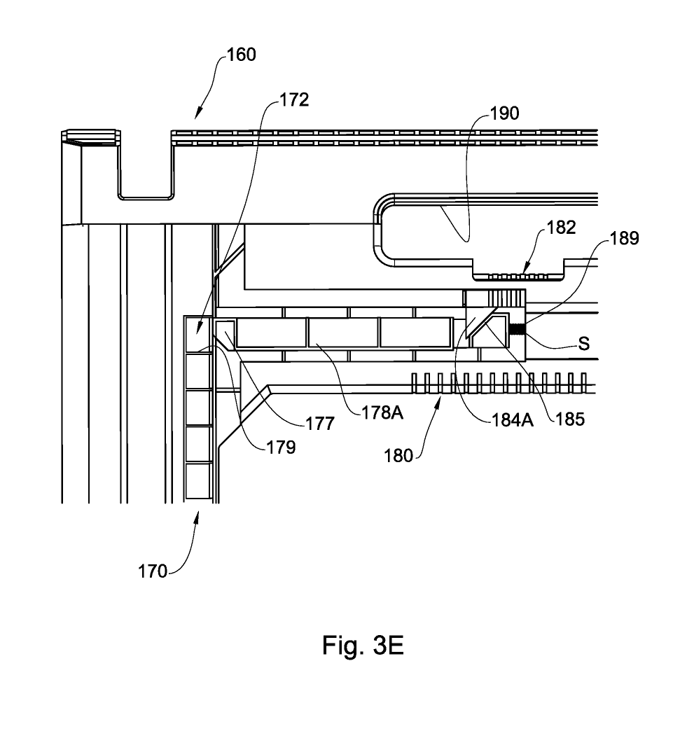

The sawhorse 100 comprises two rigid frame members 120 and 140 pivotally articulated to one another and constituting a base member 150. Each frame member 120 and 140 comprises two legs 122A, 122B and 142A, 142B, respectively, and an interconnecting support member 123 and 143, respectively, disposed at the lower end of the frame. It will be appreciated that the frames in this particular example are not identical. In fact the frame 120 is constructed of a molded plastic material whilst the frame 140 is constructed of a combination of metal and plastic material, such that the legs 142A and 142B are formed from metal although the interconnecting support member 143 is formed of plastic material as are the sleeve covers 145A and 145B for the bottom end of the legs 142A and 142B integrally formed with the interconnecting support member 143. In this particular example, the pivotal articulation of the two frames is facilitated by hingedly attaching the top edges 146A and 146B of the legs 142A and 142B around the top end of the frame 120, such that each leg of one frame 140 is articulated to the respective, opposite leg of the other frame 120 (best seen in FIG. 3A).

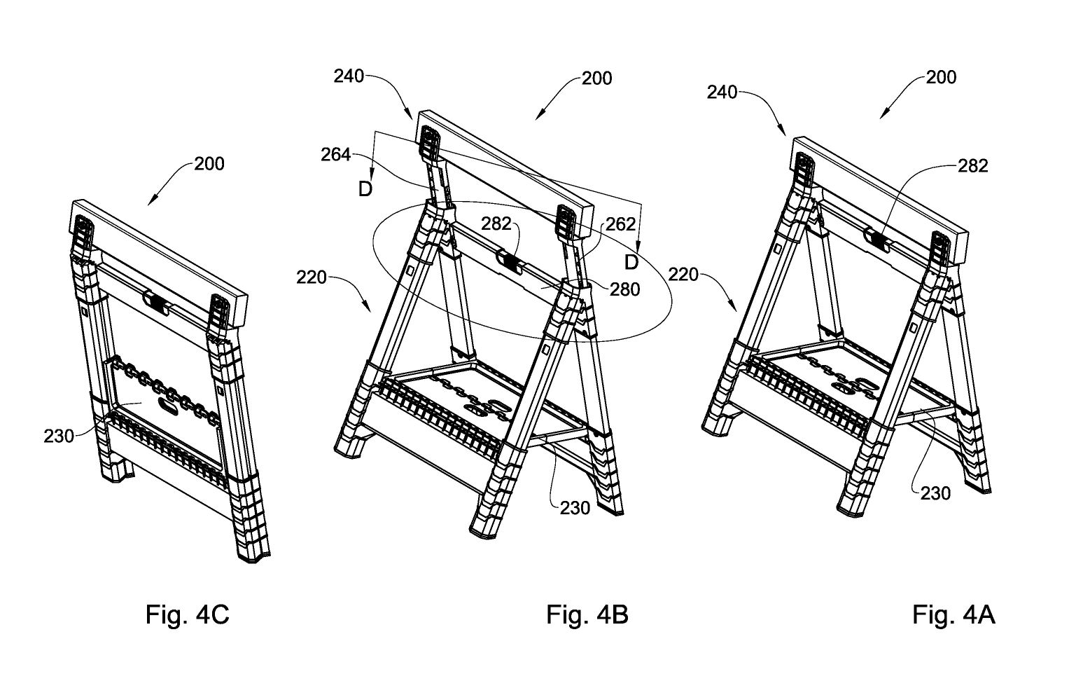

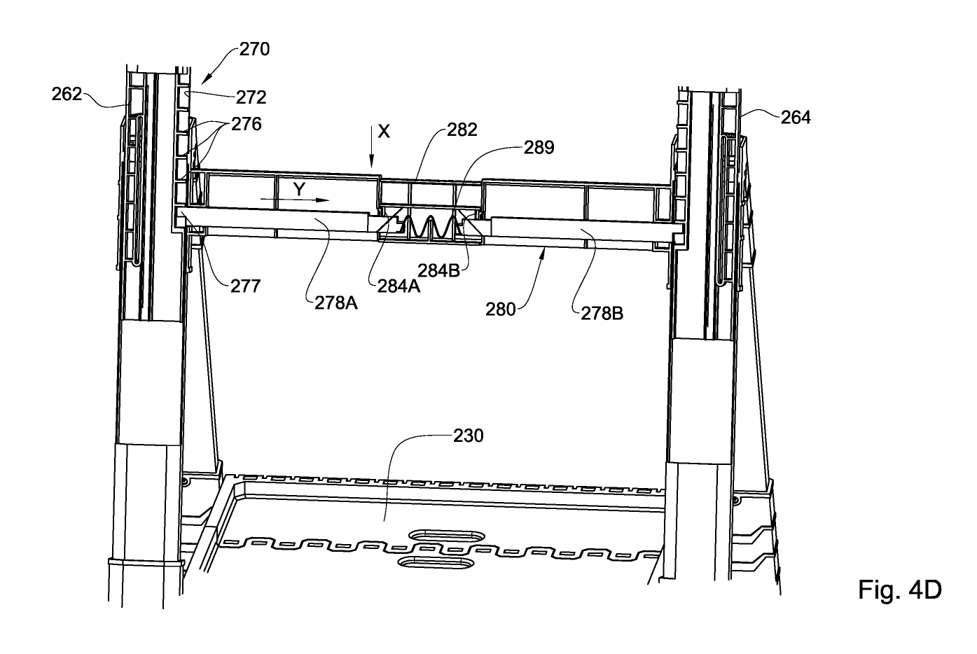

The sawhorse 100 is further provided with a shelf 130, hinged to the interconnecting support member 143 of the frame 140 through hinge H. The shelf 130 is configured to lock over the support member 123 of the frame 120 when in the deployed position, horizontally disposed between the frames 120 and 140 (FIG. 1A) and increasing the stability of the sawhorse. When the sawhorse is in its folded configuration, the shelf is configured to be disposed vertically, substantially in parallel to the leg members of the frame thus rendering the sawhorse its compact configuration for storage and transportation (FIG. 1C). It will be appreciated that other configurations of the shelf member are envisioned, e.g. a foldable shelf (seen in FIG. 4A), a shelf comprising a handle and facilitating carrying the sawhorse thereby, etc. Alternatively, the sawhorse can be devoid of such shelf entirely and it can be provided with, e.g. one or more flexible connecting members thus limiting the spread between the frames and providing stability (not shown).

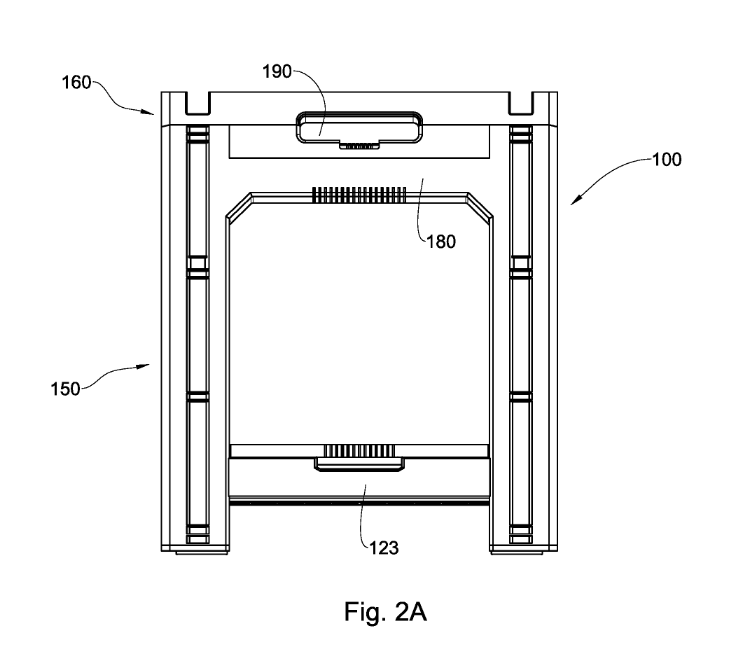

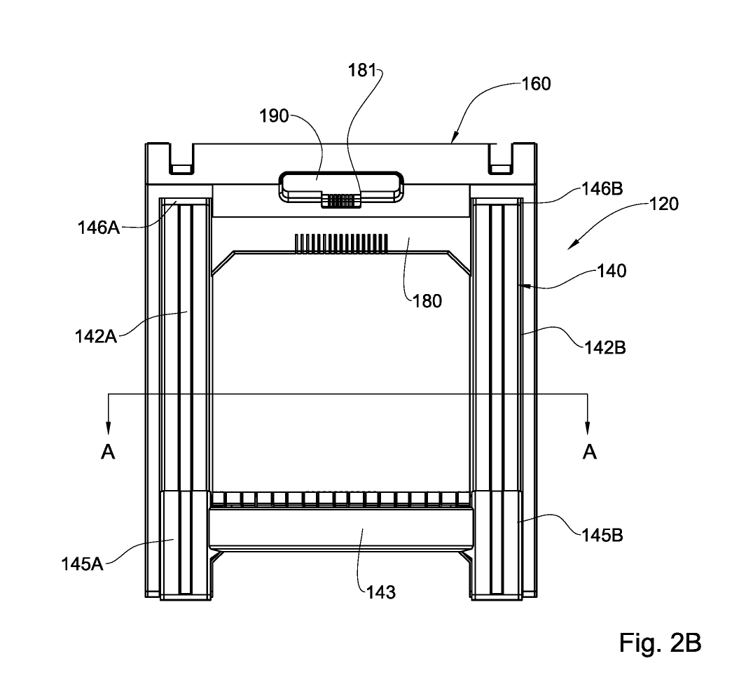

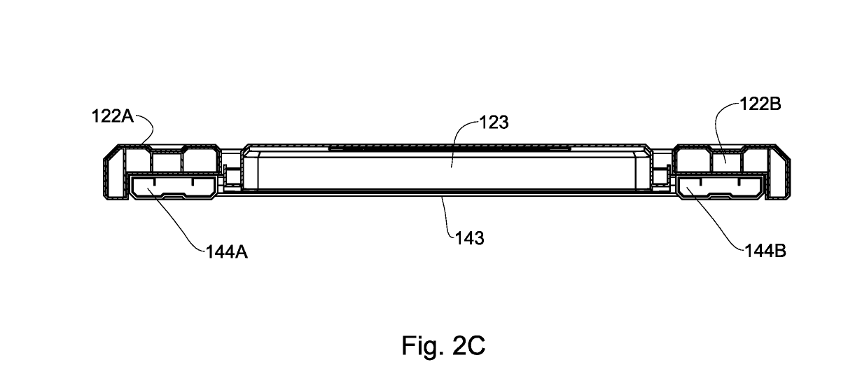

In accordance with the disclosed example, one of the frame members 120 further comprises a top utility portion 160 extending from the frame 120. In accordance with this configuration, the utility portion 160 is configured for height adjustment relative to the base member 150. To facilitate this, the utility portion 160 is provided with a pair of extension members 162, 164. These extensions are configured to be movably received within the base member. In accordance with the illustrated example, the extension members are received within two legs of the frame 120. The corresponding two legs 122A and 122B are of a hollow configuration facilitating co-axial displaceable accommodation of the extension members 162 and 164 therethrough. The arrangement is such that the legs 122A and 122B have a rectangular cross-section (e.g. seen in FIG. 2C) and the extension members 162 and 164 have a corresponding rectangular cross-section and are thus configured for snug co-axial displacement. The extension members are thus displaceable within the at least one frame member 120 between a fully retracted position (seen in FIG. 1A) and a fully extracted position (seen in FIG. 1B). It will be appreciated that the extension members can be provided with an internal halting mechanism to ensure that the extension members are not fully removed from their respective engagement in their respective leg members (not shown).

The extendible utility portion 160 is movably associated with the base member 150 for essentially vertical height adjusting movement with respect thereto to adjust the height of the sawhorse 100. The height of the sawhorse 100 can be easily adjusted by selectively adjusting the position of the extendible utility member 160 with respect to the base member 150. When stored, the utility member 160 is normally placed in its lowermost position (e.g. FIG. 1C).

As can further be seen in FIG. 1B and the cross-section in FIG. 2C, the first frame 120 is broader than the second frame 140, whereby the legs of the second frame extend within the legs of the first frame and wherein at the fully folded/collapsed state of the sawhorse 100, the legs of the second frame 140 at least partially overlap the legs of the first frame, whereby at a folded position the sawhorse has a minimal packaging volume. It will be appreciated that the legs 122A and 122B are L-shaped thus overlapping on at least two sides of the leg 144A and 144B.

Further seen in FIG. 1A, each of the legs is fitted at a bottommost portion thereof with a foot portion 111 having an anti-slip bottom surface.

The frame 120 is further provided with an interconnecting locking support member 180, extending horizontally between the frame legs 122A and 122B and integrally formed therewith.

Each of the extendible legs (extension members) 162 and 164 comprises a locking mechanism generally designated 170 (best seen in e.g. FIGS. 3A and 3E), configured for arresting the extension leg members 162, 164 with respect to the respective leg portion 122A, 122B. The locking mechanism 170 comprises a compartmentalized strip 172 integral or integrated with each of the extension leg members 162 and 164 extending vertically and facing inwards (i.e. towards the opposite leg of a respective frame). Each strip is configured with a plurality of plate-like stopping locations 179 (FIG. 3D). It will be appreciated that the locking member can be of a different configuration, e.g. cogged strip, a strip with ratchet-like teeth, etc. An arresting lever 178, each for the respective locking mechanisms associated with both extension members is coaxially received within the interconnecting support member 180 and the two levers are connected through a biasing element 189. Although in the present disclosed subject matter the biasing member is a spring S extending between the inner edges of the levers thereby interconnecting these, it will be appreciated that other types of biasing members are envisioned, e.g. an integrally formed, flexible bellows like element (289 in FIG. 4D) configured to contract and biased to expand. The arresting lever 178 and the locking mechanism 170 constitute a locking arrangement LA provided respective to each extension member 162 and 164. The lever 178 in accordance with this example has a locking end 177 configured to be latched within the compartments of the compartmentalized strip, i.e. to rest over the plates 179. The locking end can be a ratchet-tooth like edge (in the example illustrated in FIG. 3D the ratchet tooth is cut at about 45 Degrees at its bottom side, in the example illustrated in FIG. 4D, the end is non-ratchet type).

FIGS. 3D and 3E illustrate one side of the locking arrangement in accordance with an example of the disclosed subject matter. In the present example the interconnecting support member 180 is configured with a central cutout portion 181 about the center of the support 180 configured to receive a central manipulating member 182 (release mechanism) provided with downwardly extending extensions 184A and 184B configured to engage the lever 178 which in this example is provided with an opening adapted in size and shape to snugly receive the extension 184 when maneuvered as discussed (in FIGS. 3C and 3E only half of the member is illustrated as is only one lever 178A, although it will be appreciated that the other half of the member 182, i.e. the extension 184B, is configured to engage the second lever (not shown)).

The engagement between the extensions 184A and 184B and the levers 178A and 178B is such that by manipulating the member 182 by pressing in the direction of arrow X in FIG. 3D, the extensions 184A and 184B having in this example a ratchet-like tooth with a slanted wall at its inner side (i.e. facing the corresponding slanted wall 185 of the respective extension) is configured to engage the slanted wall 185 of the lever so as to facilitate sliding of the extension 184 into the lever, thereby pulling it in the direction of arrow Y, which is perpendicular to the direction of arrow X in which direction the member 182 is pressed. When pressing the central manipulating member, both arresting levers 178A and 178B can be simultaneously manipulated (e.g. by an individual using his hand) to depress the manipulating portions 184A and 184B for unlocking engagement of the end 177 (seen in 3E in the unlocked position) from the cogged/compartmentalized strip 170 and biasing the spring S such that when the manipulation member is released, the levers extend in opposite direction until engaging the respective locking mechanism at the desired position and height of the utility member. The length of the lever end 177 corresponds to the distance the lever is moved in the direction of arrow Y, thus releasing the end 177 from the locking strip 172.

The extension members 162 and 164 are configured with indicia (e.g. strip I imprinted with marks representing height or rate of extraction), wherein said indicia is visible through a window 176 formed at the leg members, such that the extent of extraction of each leg is separately indicated (e.g. FIG. 3D).

The arrangements disclosed hereinabove offer a sawhorse in which extending the height of the utility portion is easily facilitated using ones hands to pull vertically the utility portion, e.g. at the opening 190 which can further function as a carrying handle, whereby in accordance with this example the extraction of a respective extension member does not require any manipulation of the locking mechanism as it is a ratchet-type locking arrangement. It will be appreciated that the extraction of the utility portion does not depend on the sawhorse being in its deployed or collapsed positions.

In accordance with an example, retracting the extension member can be facilitated only upon manipulating and unlocking a respective locking mechanism. Even more so, it is appreciated that the extension members do not spontaneously extract, e.g. when held upside down, or tilted, owing to friction forces residing between a respective extension member and its leg members, as well as the biasing/friction force applied by the locking mechanism. For that purpose, the locking arrangement in accordance with this example is configured as a one-way locking mechanism, wherein locking is spontaneous and unlocking thereof can be facilitated only upon manipulation thereof.

FIGS. 4A to 4D illustrate a sawhorse generally designated 200 in accordance with another example of the disclosed subject matter. The sawhorse 200 differs from the sawhorse 100 in that its frame members 220 and 240 are hingedly connected at the top ends, with the leg members being formed from metal rather than from plastic materials and as such both frames are fitted with interconnecting support members integrally formed with the sleeve like plastic covers configured to receive the leg members. The shelf 230 is a foldable shelf along its center rather than a unitary shelf. In addition, the locking arrangement is such that there is provided a securing mechanism (as will be discussed below) which serves to prevent withdrawal of the extensions 262 and 264 without manipulation of the central manipulating member 282.

As best seen in FIG. 4D, the structure and elements of the locking arrangement are substantially similar with the difference residing in the structure of the locking end 277 of the arresting lever 278. The lever 278 in accordance with this example has a locking end 277 configured to be securely latched within the compartments of the compartmentalized strip locking, i.e. to rest over the plates 279 and is retracted therefrom only upon manipulation of the member 282 to engage the lever 278. Thus arrangement constituting the securing mechanism.

1. A height adjustable sawhorse, comprising two rigid frame members pivotally articulated to one another and constituting a base member, each frame member comprising two legs and further comprising a top utility portion extending from at least one of the frames, wherein the utility portion is provided with a pair of extension members axially displaceable within the at least one frame member between a fully retracted position and a fully extracted position such that at least the utility portion is configured for height adjustment relative to the base member between the two positions, and wherein the base member and the sawhorse is provided with a locking arrangement configured for locking the extension members respective of the base member at least when in the extracted position and wherein at least the displacement of the extension member into the retracted position is facilitated only upon maneuvering of the locking mechanism.

2. The height adjustable sawhorse claim 1, wherein the extension members are provided with an internal halting mechanism.

3. The height adjustable sawhorse of claim 1, wherein at least one of the frame members is further provided with an interconnecting locking support member, extending between the respective two legs of the at least one of the frame members.

4. The height adjustable sawhorse of claim 3, wherein the interconnecting locking support is integrally formed with the respective frame, forming an H-like hollow structure.

5. The height adjustable sawhorse of claim 1, wherein the extension members coaxially extend within the legs of the at least one frame member and the locking arrangement is actuatable by one or more manipulation member provided at the interconnecting locking support member.

6. The height adjustable sawhorse of claim 1, wherein the locking mechanism is configured such that the gravity force acting on the extension member is lesser than friction forces extending between the respective extension member and the base member, including such forces resulting from the locking arrangement such that the extension members are prevented from spontaneously displacing into retracted configuration.

7. The height adjustable sawhorse of claim 1, wherein the locking arrangement comprises at least one locking mechanism associated with the respective extension members configured for arresting the extension member with respect to the respective leg portion of the frame member and an arresting lever configured to engage the locking arrangement.

8. The height adjustable sawhorse of claim 1, wherein the locking arrangement comprises a ratchet type locking mechanism.

9. The height adjustable sawhorse of claim 1, wherein the extension members are telescopically received within the respective portions of the legs of the respective frame.

10. The height adjustable sawhorse of claim 1, wherein the locking arrangement is configured with a biasing mechanism for retaining the locking mechanism at a normally locked position.

11. The height adjustable sawhorse of claim 1, wherein the biasing mechanism is integrally formed with at least a portion of the locking mechanism, and/or wherein the biasing mechanism is a biasing spring configured to contract and biased to expand.

12. (canceled)

13. The height adjustable sawhorse of claim 1, wherein the locking arrangement comprises a lever or a bolt member associated with a locking mechanism provided to engage the locking mechanism associated with each of the extension members and actuatable by a common manipulating member.

14. The height adjustable sawhorse of claim 13, wherein the arresting lever for the respective locking mechanisms associated with the extension members is coaxially received within the interconnecting support member

15. The height adjustable sawhorse of claim 13, wherein the respective arresting levers are interconnected through a biasing element, together extending within the interconnecting support member and configured to engage the arresting mechanism of the extension members, constituting together a locking arrangement.

16. The height adjustable sawhorse of claim 13, wherein the respective arresting lever is configured with a locking end for latch type engagement with the arresting member.

17. The height adjustable sawhorse of claim 13, wherein the interconnecting support member is configured with a central manipulating member extending therein for manipulation of the respective levers and exposed for manipulation.

18. The height adjustable sawhorse of claim 13, wherein the interconnecting support member is configured with a central manipulating member for manipulation of the respective levers, the manipulating member being provided with downwardly extending extensions configured to engage the respective lever provided with a receiving member to snugly receive the extension when maneuvered.

19. The height adjustable sawhorse of claim 18, wherein the respective engagement between the extensions and the levers is achieved by manipulating the manipulation member.

20. The height adjustable sawhorse of claim 18, the length of the locking lever end corresponds to the width of the downwardly extending extension of the manipulating member.

21. The height adjustable sawhorse of claim 13, wherein the two levers or bolt members associated with the locking members of the two extension members are configured with a biasing mechanism for retaining the locking arrangement at a normally locked position.
